(19) United States
(12) Patent Application Publication
(10) Pub. No.: US 2011/0048745 A1
(43) Pub. Date: Mar. 3, 2011

(54) WATER FLOW DETECTION DEVICE

(76) Inventor: Yukinori Karihara, Iwate (JP)

(21) Appl. No.: 12/988,574

(22) PCT Filed: Apr. 23, 2009
(86) PCT No.: PCT/JP2009/001856

§ 371 Date: Nov. 12, 2010

(30) Foreign Application Priority Data
Apr. 23, 2008 (JP) 2008/001057

(51) Int. Cl. A62C 35/68

(52) U.S. Cl. 169/23; 137/551

(57) ABSTRACT

A water flow detection device is provided in which strength and water proof performance of the switch box that protects a switch or the like of the water flow detection device are improved and the workability of wiring work of signal line and checking work is good. In the water flow detection device, the inside of the main body has a check valve structure, and a signal output means for detecting opening of a valve body and outputting a signal is contained in a housing connected to the main body. The housing includes a base and a cover. The base includes a first surface that is a surface connecting to the main body and a second surface formed by extending and bending the first surface. The cover is engaged with an edge of the first surface opposite to the second surface and covers the signal output means. A fixing means of the cover is provided at one position in a marginal edge of the second surface.

### TECHNICAL FIELD

The present invention relates to a water flow detection device installed on a pipe of a fire extinguishing system.

### BACKGROUND ART

The water flow detection device is installed on a pipe of a fire extinguishing system such as a sprinkler system and a foam extinguishing system, and detects water flow in the pipe and outputs a signal.

The inside of the water flow detection device has a check valve structure. The inside is divided into a primary chamber and a secondary chamber by a valve and a valve body is normally closed. The primary chamber and the secondary chamber are normally filled with water. A pipe connected to the primary chamber (hereinafter referred to “primary pipe”) is connected to a water source and a pipe connected to the secondary chamber (hereinafter referred to “secondary pipe”) is connected to a spraying head such as a sprinkler head or a foam head.

The water flow detection device is installed to detect actuation of the spraying head installed on the secondary pipe. For example, when a sprinkler head is actuated, the water filled in the secondary pipe is discharged from the sprinkler head, so that the pressure in the secondary pipe reduces. Based on this, the pressure in the secondary chamber of the water flow detection device decreases, the balance of force applied to the valve body is lost, the force applied to the valve body from the primary chamber exceeds the force applied to the valve body from the secondary chamber, and thus, the valve body is opened.

When the opening of the valve body is detected, the switch device is actuated and a signal is outputted. The outputted signal is transmitted to a monitoring device installed in an administrative room of the building, and the signal from the monitoring device notifies an administrator that the sprinkler head is actuated.

The water flow detection device having the check valve structure described above includes a type in which a hole leading to the outside is drilled in a valve seat on which a valve body seats, the hole is connected to a pressure switch, and the pressure switch generates a signal (for example, see Patent Document 1), and a type in which a displacement caused by opening of a valve body is detected and a signal is generated (for example, see Patent Documents 2 and 3).

Patent Document 1: Japanese Examined Utility Model Registration Application Publication No. 61-14780

Patent Document 2: Japanese Unexamined Patent Application Publication No. 09-99114

Patent Document 3: Japanese Unexamined Patent Application Publication No. 2006-55400

### DISCLOSURE OF THE INVENTION

### Problems to be Solved by the Invention

In the latter type of water flow detection device, a switch outputting a signal included in the water flow detection device of Patent Documents 2 and 3 is covered by a switch box or a housing, and protected from dust and moisture. Many of the switch boxes or the like are made of resin for decreasing weight and reducing cost.

However, in recent years, strength and water proof performance are required for the switch box and the housing, and for handling of the device, requests such as, the wiring work of the signal line connected to the monitoring device should be performed easily, attaching and detaching of the switch box and the housing should be performed simply, and so on have been increased.

In view of the above problems, an object of the present invention is to provide a water flow detection device in which strength and water proof performance of the switch box that protects a switch or the like of the water flow detection device are improved and the workability of wiring work of signal line and checking work is good.

### Means for Solving the Problems

(1) A water flow detection device of the present invention that achieves the above object is installed on a pipe of a fire extinguishing system, and is including a main body including a check valve structure therein and a housing containing a signal output means for detecting opening of the valve body having the check valve structure and outputting a signal, wherein the housing includes a base and a cover, the base has a first surface that is a surface connecting to the main body and a second surface formed by extending and bending the first surface into an L-shape, and the cover is attachably and detachably fixed to the first surface and the second surface of the base and covers the signal output means.

(2) The above-described present invention is characterized in that the cover has an engaging section for engaging with an edge of the first surface of the base opposite to the second surface and a fixing means for fixing the cover to the second surface of the base.

(3) The above-described present invention is characterized in that the fixing means is provided at one position in a marginal edge of the second surface of the base.

(4) The above-described present invention is characterized in that the second surface of the base is a bottom surface of the housing and a passing hole through which a lead wire connected from the outside to the signal output means passes is formed on the bottom surface.

(5) The above-described present invention is characterized in that a bracket for supporting the signal output means inside the housing is provided on the base.

(6) The above-described present invention is characterized in that the bracket includes a lower mounting portion which supports the signal output means and a upper mounting portion which is extended upward from the lower mounting portion, bended into a reverse L-shape, and supports a terminal block to which a lead wire from the outside to be connected to the signal output means is connected.

(7) The above-described present invention is characterized in that an opening for mounting a signal stop means that prevents the signal output means from outputting a signal is provided in the bracket.

(8) The above-described present invention is characterized in that the fixing means is a fastener member for performing fixing by screwing a screw into an internal thread.

(9) The above-described present invention is characterized in that a cross-section of the engaging section of the cover has a reverse U-shape that engages with the edge of the first surface of the base from the above.

(10) The above-described present invention is characterized in that a rail that is able to guide a sliding movement of the cover on the base is provided on an inner surface of the base.

(11) The above-described present invention is characterized in that the rail is provided in a direction of inserting and extracting the engaging section into and from the edge of the first surface of the base.

(12) The above-described present invention is characterized in that the rail is provided in a continuous form connected from the first surface to the second surface.

(13) The above-described present invention is characterized in that the rail is formed to protrude toward inside of the housing.

(14) The above-described present invention is characterized in that a signal stop means for preventing the signal output means from outputting a signal is disposed inside the housing.

(15) The above-described present invention is characterized in that a signal stop means for preventing the signal output means from outputting a signal is provided integrally with the cover.

### ADVANTAGES

(1) In the present invention, the housing includes a base and a cover, the base has a first surface that is a surface connecting to the main body and a second surface formed by extending and bending the first surface into an L-shape, and the cover is attachably and detachably fixed to the first surface and the second surface of the base and covers the signal output means.

When the cover is removed, the internal structure of the housing supported by the L-shaped base is largely exposed, so that the workability of wiring work and checking work of the signal output means or the like inside the housing is good. By forming the base into an L-shape, different components and constituent elements can be mounted respectively on the first surface and the second surface, so that the space of the housing can be saved as a whole. For example, it is possible to provide a bracket for supporting the signal output means on the first surface and form a passing hole through which a lead wire connected from the outside to the signal output means passes on the second surface, so that the space of the housing can be saved compared with a case in which a bracket and a passing hole through which a lead wire passes are provided on the base having a shape of a flat plate.

(2) In the present invention, the cover has an engaging section for engaging with an edge of the first surface of the base opposite to the second surface and a fixing means for fixing the cover to the second surface of the base. Therefore, when attaching the cover, if the fixing means is a screw, it is possible to fix the cover to the base only by fastening one screw, so that the cover can be easily removed and attached with a good workability when performing wiring work or checking work.

(3) In the present invention, the fixing means is provided at one position in a marginal edge of the second surface of the base. Therefore, when attaching the cover, if the fixing means is a screw, it is possible to fix the cover to the base only by fastening one screw, so that the cover can be easily removed and attached with a good workability when performing wiring work or checking work.

(4) In the present invention, the second surface of the base is the bottom surface of the housing and the passing hole through which the lead wire connected from the outside to the signal output means passes is provided in the bottom surface, so that the space of the housing can be saved compared with, for example, a case in which a bracket and a passing hole through which a lead wire passes are provided together on the base having a shape of a flat plate.

(5) In the present invention, the bracket for supporting the signal output means inside the housing is provided on the first surface of the base, so that the space of the housing can be saved compared with, for example, a case in which a bracket and a passing hole through which a lead wire passes are provided together on the base having a shape of a flat plate.

(6) In the present invention, the bracket includes a lower mounting portion which supports the signal output means and a upper mounting portion which is extended upward from the lower mounting portion, bended into a reverse L-shape, and supports a terminal block to which a lead wire from the outside to be connected to the signal output means is connected. Therefore, the signal output means and the terminal block that are contained in the housing can be disposed separately from each other to an upper section and a lower section, so that the space of the housing can be saved. Since the terminal block is mounted on the bracket, the terminal block is located near the signal output means, so that the length of the lead wire connecting the signal output means with the terminal block can be shortened. Or, the terminal of the signal output means can be directly connected to the terminal block.

(7) In the present invention, an opening for mounting a signal stop means that prevents the signal output means from outputting a signal is provided in the bracket, so that the signal stop means can be easily mounted in an appropriate position.

(8) In the present invention, since the fixing means is a fastener member for performing fixing by screwing a screw into an internal thread, for example, when the fastener member is a screw, it is possible to fix the cover to the base only by fastening the screw. Therefore, the cover can be easily removed and attached with a good workability when performing wiring work or checking work.

(9) In the present invention, the cross-section of the engaging section of the cover has a reverse U-shape that engages with the edge of the first surface of the base from the above, so that the engaging section of the cover having the reverse U-shape cross-section is fitted into the first surface. Therefore, the engagement can be reliably performed, and there is an effect that water is prevented from infiltrating into the inside of the base.

(10) In the present invention, a rail that is able to guide a sliding movement of the cover on the base is provided on an inner surface of the base. Therefore, a structure in which the cover slides along the rail can be employed.

(11) In the present invention, the rail is provided in a direction of inserting and extracting the engaging section into and from the edge of the first surface of the base. Therefore, the sliding movement of the cover can be guided by the rail according to the direction of mounting the cover on the base, in other words, the direction of inserting and extracting the engaging section.

(12) In the present invention, the rail is provided in a continuous form connected from the first surface to the second surface. Therefore, a structure in which the cover slides along the rail on the first surface and the second surface can be employed.

(13) In the present invention, the rail is formed to protrude toward inside of the housing, so that the rail can exert an effect of reinforcing the base.

(14) In the present invention, a signal stop means for preventing the signal output means from outputting a signal is disposed inside the housing, so that the signal stop means need not be carried around when performing checking work or maintenance work.

(15) In the present invention, a signal stop means for preventing the signal output means from outputting a signal is provided integrally with the cover, so that the signal stop means need not be prepared as a separate component, and the number of components can be reduced, and further, it is possible to prevent the signal stop means prepared as a separate component from being lost.

### BRIEF DESCRIPTION OF DRAWINGS

FIG. 1 is a cross-sectional view of a water flow detection device according to an embodiment of the present invention.

FIG. 2 is a cross-sectional view taken along line II-II in FIG. 1.

FIG. 3 is a cross-sectional view taken along line III-III in FIG. 2.

FIG. 4 is an enlarged view of a housing portion in FIG. 3.

FIG. 5 is an enlarged illustration of an area around a limit switch showing how to use a signal stop means.

FIG. 6 is a side view of FIG. 4.

FIG. 7 is a perspective view of a base.

FIG. 8 is a perspective view of a cover.

FIG. 9 is an enlarged illustration of an area around a limit switch showing a usage state of a signal stop means according to another embodiment.

FIG. 10 is a base according to another embodiment.

### BEST MODES FOR CARRYING OUT THE INVENTION

It is preferred that the first surface of the base is provided on the side surface of the water flow detection device. Although the fixing means of the cover is provided in a marginal edge of the second surface, the fixing means may be a female screw that is screwed into a hole penetrating the cover and the base when the cover is attached to the base. As other fixing means, anything that can attachably and detachably fix the cover to the base can be used, such as a pin inserted instead of the female screw, an adhesive tape, a band, and so on.

When the rail that is provided on the inner surface of the base and connected from the first surface to the second surface is a protrusion having a cross-section of a convex shape, it is possible to provide a step along the marginal edge of the cover that is slid along the protrusion and enable the step to slide along the side surface of the protrusion. When the rail has a cross-section of a concave shape, the cover can slide while the edge portion of the cover is fitted into the concave portion.

When the signal output means is a limit switch, the bracket that supports the signal output means on the first surface is preferred to have a structure in which the limit switch is fixed to the bracket so that the position of the limit switch is located at an appropriate position with respect to the base.

In addition to the limit switch, a limit switch pressing means for transmitting a movement of the detection rod moved by the opening of the valve in the main body of the water flow detection device to the limit switch and a delay means for delaying the movement of the limit switch pressing means may be provided in the bracket.

Further, a terminal block connected to the limit switch can be placed on the surface of the bracket, or the terminal block and the terminal of the limit switch can be directly connected to each other.

In the bracket, an opening for mounting a signal stop means for preventing the limit switch from being actuated when performing checking of the water flow detection device in an appropriate position can be provided. By mounting the signal stop means having a rod shape on the opening, the signal stop means lies between the limit switch and the limit switch pressing means, so that it is possible to prevent the limit switch pressing means from moving toward the limit switch.

The signal stop means can be contained in the housing, and a latching section of the signal stop means may be provided in the housing. Or, the signal stop means can be formed integrally with the cover as a part of the cover.

### First Embodiment

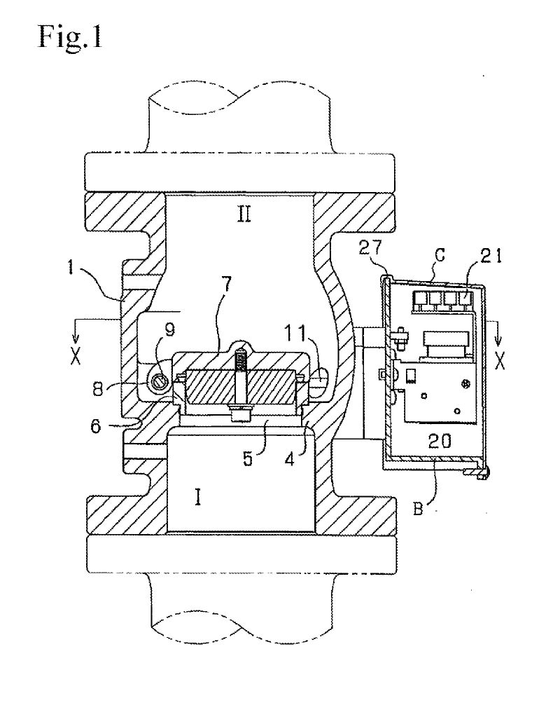

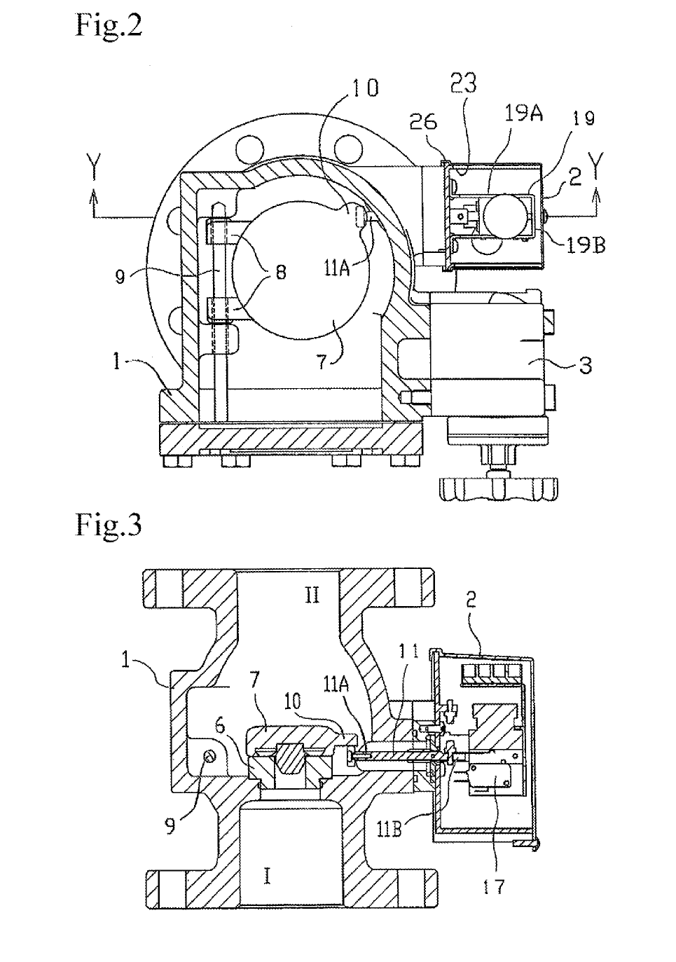

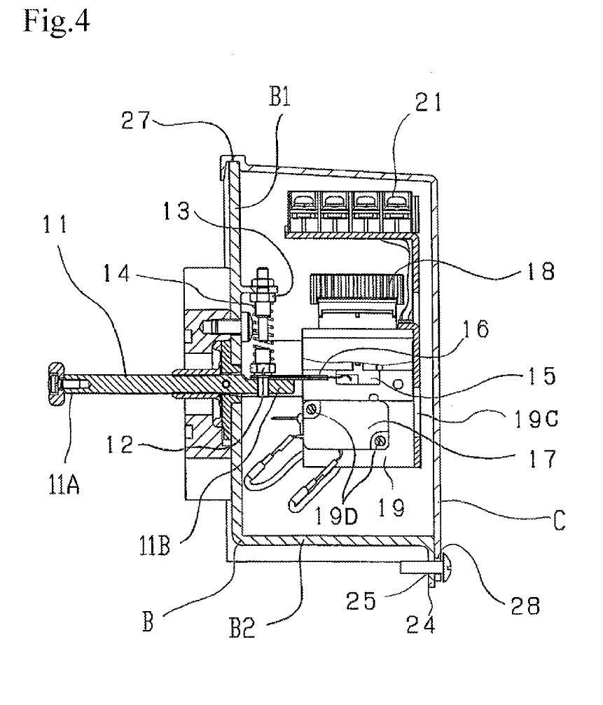

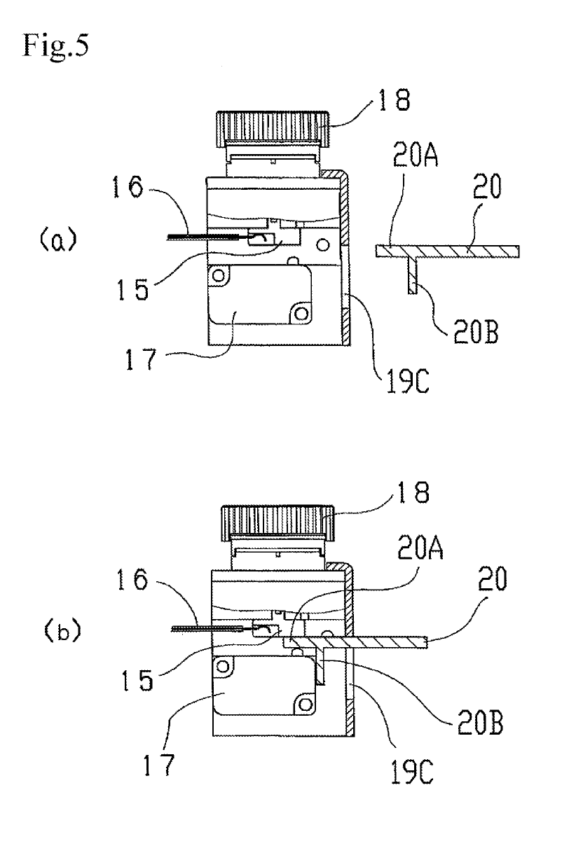

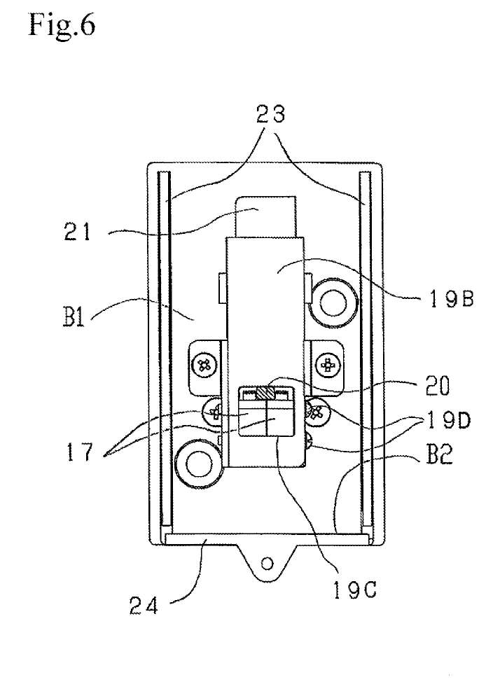

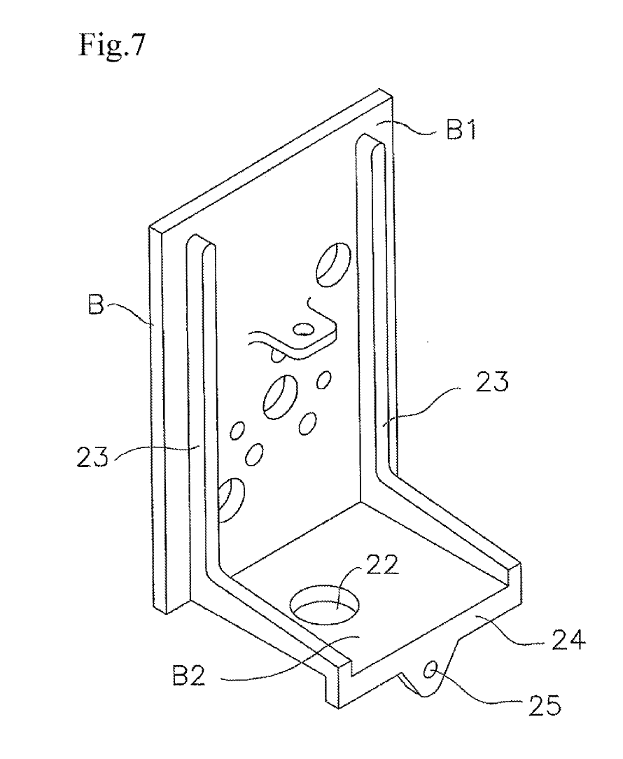

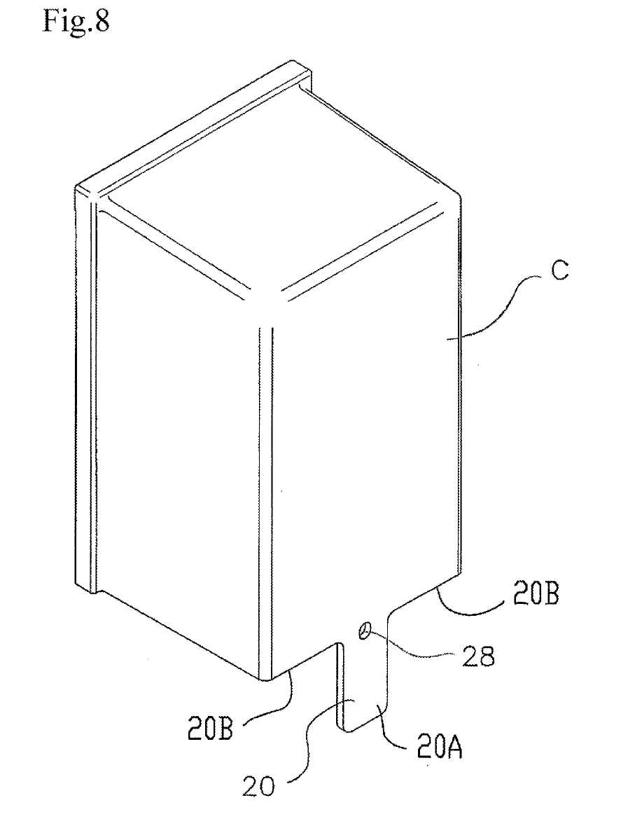

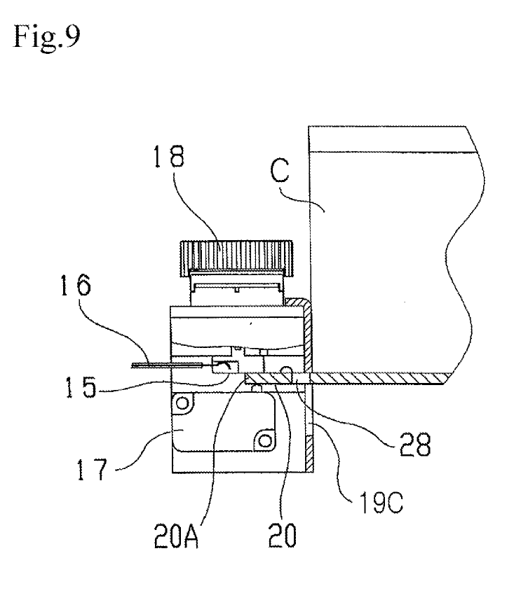

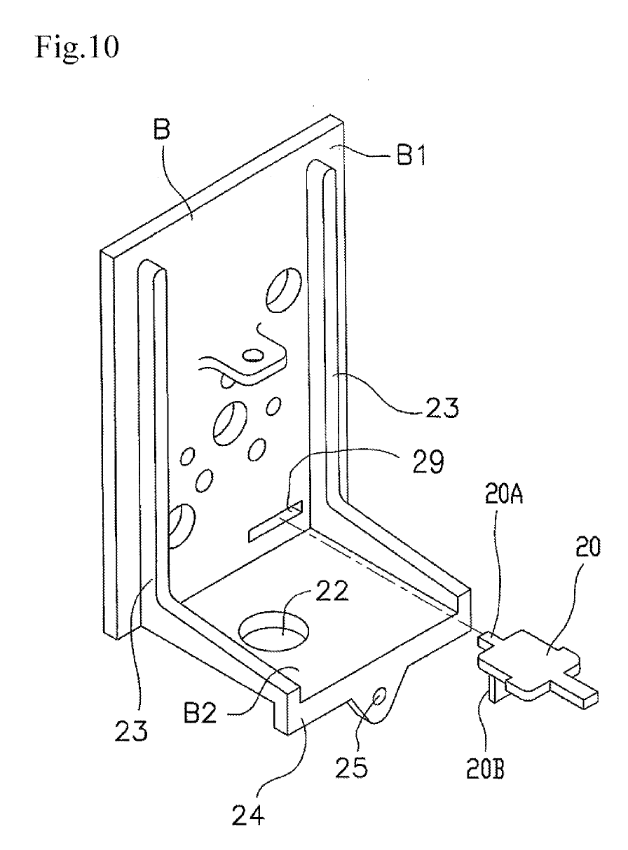

Hereinafter, a first embodiment of the present invention will be described with reference to FIGS. 1 to 10. FIG. 1 is a cross-sectional view of a water flow detection device according to the present invention. FIG. 2 is a cross-sectional view taken along line II-II in FIG. 1. FIG. 3 is a cross-sectional view taken along line III-III in FIG. 2. FIG. 4 is an enlarged view of a housing portion in FIG. 3. FIG. 5 is an enlarged illustration of an area showing how to use a signal stop means. FIG. 6 is a side view of FIG. 4. FIG. 7 is a perspective view of a base. FIG. 8 is a perspective view of a cover. FIG. 9 is an enlarged illustration of an area showing a usage state of a signal stop means according to another embodiment. FIG. 10 is a base according to another embodiment. For convenience of drawing figures, a lead wire connecting the limit switch with the terminal block is not shown in the figures except for FIG. 4.

The water flow detection device according to the present invention shown in FIGS. 1 to 3 includes a main body 1, a housing 2, and a drain valve 3.

The main body 1 has a hollow shape and the inside of the main body 1 is divided into a primary chamber I and a secondary chamber II by a bulkhead 4. A link hole 5 is drilled in the bulkhead 4, and a ring-shaped valve seat 6 is placed around the link hole 5 in the secondary chamber II.

A valve body 7 seats on the valve seat 6, cylinder-shaped bearings 8 are formed on parts of the circumference of the valve body 7, and a valve shaft 9 passes through the bearings 8 and is placed in the main body 1. The valve body 7 is configured to be able to rotate and move toward the secondary chamber II by using the valve shaft 9 as an axis, and when the valve body 7 rotates and moves, the valve body 7 is separated from the valve seat 6, and a fluid in the primary chamber can pass through the ring-shaped valve seat 6 to the secondary chamber II.

A protrusion portion 10 is formed to protrude from the circumference of the valve body 7. An end portion 11A of a detection rod 11 is in contact with the surface of the protrusion portion 10 facing the valve seat 6, the detection rod 11 is intermediately and pivotally supported, and the detection rod 11 is configured to be able to rotate and move vertically in the figures.

An end portion 11B of the detection rod 11 opposite to the end portion in contact with the valve body 7 protrudes to the outside of the main body 1 and is covered by the housing 2. As shown in FIG. 4, a spring washer 12 protruding upward in FIG. 4 is placed on the end portion 11B, a spring washer 13 placed on a base B is provided coaxially with the spring washer 12, and a coil spring 14 is provided as a resilient body between both spring washers 12 and 13.

The end portion 11B of the detection rod 11 is always urged downward in FIG. 4 by the coil spring 14. The end portion 11A opposite to the end portion 11B is urged upward in FIG. 4, in other words, urged in the direction to open the valve body 7, by a shaft located in the middle of the detection rod 11. However, the force applied by the coil spring 14 is too weak to open the valve body 7.

A terminal 16 which comes into contact with a limit switch pressing means 15 is fixed to the end portion 11B of the detection rod 11. The terminal 16 urges the limit switch pressing means 15 in the direction to distance from the limit switch 17 by the action of a curved spring portion attached to the end of the terminal 16.

A delay mechanism 18 is placed in the direction in which the spring portion at the end of the terminal 16 urges the limit switch pressing means 15. The delay mechanism 18 has a function to delay the action of the limit switch pressing means 15, and has a structure in which an air damper or an oil damper is used. A detailed description of the delay mechanism 18 will be omitted.

A bracket 19 which covers the limit switch pressing means 15, the limit switch 17, and the delay mechanism 18 is formed by three planes having a squared U shape in cross-section. The above constituent elements 15, 17, and 18 are disposed between planes 19A facing each other, and the constituent elements are respectively placed at predetermined positions by screws 19D penetrating the two planes. An edge portion of the plane 19A of the bracket 19 is folded in parallel with a surface B1 of the base B, and fixed to the surface B1 of the base B by a screw or the like (refer to FIGS. 2 and 5).

An opening 19C is formed in a plane 19B provided perpendicular to the two planes 19A facing each other of the bracket 19 shown in FIGS. 3 to 5. The opening 19C is formed to mount a signal stop means 20 that prevents the limit switch pressing means 15 from moving to the limit switch 17. When inserting an top end portion 20A of the signal stop means 20 having a rod shape into the opening 19C, the limit switch pressing means 15 is prevented from moving to the limit switch 17. FIGS. 5 and 6 show a cross-section of the signal stop means 20.

To mount the signal stop means 20 in an appropriate position, a brim portion 20B is formed in the middle of the signal stop means 20, so that the insertion amount of the top end portion 20A is regulated and the signal stop means 20 is mounted in an appropriate position (refer to FIG. 5).

The plane 19B of the bracket 19 is formed to extend above the delay mechanism 18 in the figures, and a terminal block 21 is mounted on the plane 19B. In this way, the limit switch 17 and the terminal block 21 can be disposed separately from each other to an upper section and a lower section in the housing 2, so that the space of the housing 2 can be saved. Since the terminal block 21 is mounted on the bracket 19, the terminal block 21 can be located near the limit switch 17, so that the length of the lead wire connecting them to each other can be shortened. The mounting position of the terminal block 21 is not limited to the area above the delay mechanism 18, but the terminal block 18 may be mounted on the surface of the plate 19A of the bracket 19, or may be mounted on an area other than the bracket 19, for example, on the base B.

The base B of the housing 2 shown in FIG. 7 has an L-shape formed by bending a flat plate, and includes a surface B1 as a “first surface” through which the detection rod 11 penetrates and is connected with the main body 1 and a surface B2 as a “second surface” formed by extending and bending the surface B1. The edge portion of the plane 19A of the bracket 19 is connected to the surface B1, and a hole 22, from which the lead wire to be connected to the terminal block 21 from the outside is inserted into the housing 2, is drilled in the surface B2. By forming the base B into an L-bended-shape, different components and constituent elements can be mounted respectively on the surface B1 and the surface B2, so that the space of the housing 2 can be saved as a whole compared with, for example, a case in which the base is formed into one flat plate and a bracket and a passing hole through which a lead wire passes are formed.

On the inner surface of the base B, rails 23 continuing from the surface B1 to the surface B2 are formed. The rails 23 can guide a sliding movement of the cover C on the base B when the cover C is attached or detached, and also can reinforce the structure of the base B. The cross-section of the rail 23 has a convex shape. A hole 25 for fixing the cover C that covers the base B is included in a side 24 of the surface B2 facing the surface B1, and an internal thread is formed inside the hold 25.

The cover C covers the limit switch 17, the delay mechanism 18, and the terminal block 21 mounted on the base B and protects them from dust and water. When the cover C is removed, the internal structure of the housing 2 supported by the L-shaped base B is largely exposed, so that the workability of wiring work and checking work of the limit switch 17, the terminal block 21, and the like contained in the housing 2 is good. A step portion 26 is formed on the cover C so that the cover C can be slid along the rails 23 of the base B (refer to FIG. 2). A cross-sectional shape of a portion of the cover C corresponding to the upper edge of the surface B1 of the base B is formed into a reversed U-shape, and when the cover C is attached to the base B, the reversed U-shaped portion 27 as an “engaging section” is fitted and latched in the upper edge of the surface B1 of the base B (refer to FIG. 4). Therefore, the cover C can be reliably engaged with the base B, and the engaging structure can prevent water from infiltrating into the inside of the base B.

In the cover C, a hole 28 is formed which is coaxial with the hole 25 provided in the marginal edge of the surface B2 of the base B when the cover C is attached to the base B. When a screw is inserted into the hole 28 and screwed into the internal thread of the hole 25 in the base B, the cover C is fixed to the base B. In this way, the attaching and detaching works of the cover C to and from the base B can be carried out only by fastening or loosening a screw, so that wiring work and checking work can be easily performed with good workability.

The above-mentioned signal stop means 20 can be formed integrally with the cover C. Specifically, as shown in FIG. 8, a protrusion portion 20 as the “signal stop means” can be provided on the cover C, and this can be used as shown in FIG. 9. By doing so, the signal stop means 20 need not be prepared as a separate component, and the number of components can be reduced, and further, it is possible to prevent the signal stop means 20 that need not be prepared as a separate component from being lost. Or, the protrusion portion can be provided on the inner surface of the cover C. As shown in FIG. 10, by providing an engaging hole 29 in the base B, the above-mentioned signal stop means 20 can be placed in the housing 2 when not in use, so that the signal stop means 20 need not be carried around when performing checking work or maintenance work.

The drain valve 3 is a valve for draining the fluid in the main body 1 to the outside when performing checking or maintenance. The drain valve 3 is placed adjacent to the housing 2. The inside of the drain valve 3 has an angle valve structure, and an outlet is provided facing downward in FIG. 1. A handle for opening and closing the drain valve 3 is placed in front side, and at a location where the handle can be operated easily.

Next, the actuation of the water flow detection device according to the present invention will be described.

The above-mentioned water flow detection device is installed on a pipe of a fire extinguishing system. The primary chamber I is connected to a pipe that is connected to a pump and a water source not shown in the figures, and a sprinkler head not shown in the figures is mounted at an end of a pipe connected to the second chamber II.

The pipe of the fire extinguishing system is filled with water, and inside the main body 1 of the water flow detection device, both the primary chamber I and the secondary chamber II are filled with water. Normally, the valve body 7 seats on the valve seat 6, and a water flow from the primary chamber I to the secondary chamber II is blocked.

When a fire breaks out and the sprinkler head mounted on the pipe connected to the secondary chamber II is actuated, the water in the secondary chamber II is discharged from the sprinkler head, so that the pressure of the water in the pipe connected to the secondary chamber gradually reduces. When the pressure of the water in the secondary chamber II which closes the valve body 7 decreases, the valve body 7 is pushed up by the pressure of the water in the first chamber I, and rotates around the shaft 9.

When the valve body 7 is separated from the valve seat 6 and opened, the water in the primary chamber I is sent to the secondary chamber II. At the same time, the detection rod 11 in contact with the valve body 7 rotates by the urging force of the coil spring 14, and the end portion 11B in the housing 2 moves downward in FIG. 4.

Based on this, the terminal 16 of the end portion 11B is separated from the limit switch pressing means 14, and the limit switch pressing means 15 starts to move toward the limit switch 17. The limit switch pressing means 15 actuates the limit switch 17 after a predetermined period of time elapses by using the delay mechanism 18, and a signal of the limit switch 17 is transmitted to a monitoring device placed in the building manager office via the lead wire connected to the terminal block 21.

The above-mentioned pump is started by the signal from the limit switch 17, water supply is started from the water source to the actuated sprinkler head, water is continuously sprayed from the sprinkler head, and the fire is extinguished.

### REFERENCE NUMERALS

1 main body of water flow detection device
2 housing
3 drain valve
6 valve seat
7 valve body
9 valve shaft
11 detection rod
12, 13 spring washer
14 coil spring
15 limit switch pressing means
17 limit switch
18 delay mechanism
19 bracket
20 signal stop means
21 terminal block
23 rail
B base
C cover

1. A water flow detection device installed on a pipe of a fire extinguishing system, the water flow detection device comprising:
a main body including a check valve structure therein; and
a housing containing a signal output means for detecting opening of the valve body having the check valve structure and outputting a signal;
wherein the housing includes a base and a cover,
the base has a first surface that is a surface connecting to the main body and a second surface formed by extending and bending the first surface into an L-shape
the cover is attachably and detachably fixed to the first surface and the second surface of the base and covers the signal output means, and
the cover has an engaging section for engaging with an edge of the first surface of the base opposite to the second surface and a fixing means for fixing the cover to the second surface of the base.

2. (canceled)

3. The water flow detection device according to claim 1, wherein the fixing means is provided at one position in a marginal edge of the second surface of the base.

4. The water flow detection device according to claim 1, wherein the second surface of the base is a bottom surface of the housing and a passing hole through which a lead wire connected from the outside to the signal output means passes is formed on the bottom surface.

5. The water flow detection device according to claim 1, wherein a bracket for supporting the signal output means inside the housing is provided on the first surface of the base.

6. The water flow detection device according claim 5, wherein the bracket includes a lower mounting portion which supports the signal output means and a upper mounting portion which is extended upward from the lower mounting portion, bended into a reverse L-shape, and supports a terminal block to which a lead wire from the outside to be connected to the signal output means is connected.

7. The water flow detection device according to claim 5, wherein an opening for mounting a signal stop means that prevents the signal output means from outputting a signal is provided in the bracket.

8. The water flow detection device according to claim 1, wherein the fixing means is a fastener member for performing fixing by screwing a screw into an internal thread.

9. The water flow detection device according to claim 1, wherein a cross-section of the engaging section of the cover has a reverse U-shape that engages with the edge of the first surface of the base from the above.

10. The water flow detection device according to claim 1, wherein a rail that is able to guide a sliding movement of the cover on the base is provided on an inner surface of the base.

11. The water flow detection device according to claim 10, wherein the rail is provided in a direction of inserting and extracting the engaging section into and from the edge of the first surface of the base.

12. The water flow detection device according to claim 10, wherein the rail is provided in a continuous form connected from the first surface to the second surface.

13. The water flow detection device according to claim 10, wherein the rail is formed to protrude toward inside of the housing.

14. The water flow detection device according to claim 1, wherein a signal stop means for preventing the signal output means from outputting a signal is disposed inside the housing.

15. The water flow detection device according to claim 1, wherein a signal stop means for preventing the signal output means from outputting a signal is provided integrally with the cover.
